(19) United States
(12) Patent Application Publication
(10) Pub. No.: US 2013/0017735 A1
(43) Pub. Date: Jan. 17, 2013

(54) COMPUTER MEMORY DEVICE

(71) Applicants: QI-YAN LUO, Shenzhen City (CN); PENG CHEN, Shenzhen City (CN); SONG-LIN TONG, Shenzhen City (CN)

(72) Inventors: QI-YAN LUO, Shenzhen City (CN); PENG CHEN, Shenzhen City (CN); SONG-LIN TONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/212,178

(22) Filed: Aug. 18, 2011

(30) Foreign Application Priority Data
Jul. 14, 2011 (CN) 201110196977.1

(51) Int. Cl. H01R 13/04

(52) U.S. Cl. 439/692

(57) ABSTRACT

A computer memory device includes a circuit board, a number of chips mounted on a surface of the circuit board, and an edge connector set on a bottom side of the circuit board. The edge connector includes ground pins, power pins, and data pins. Top ends of the ground pins, the power pins, and the data pins are in alignment with one another. Each ground pin is longer than each of the power pins and the data pins.

### BACKGROUND

1. Technical Field

The present disclosure relates to a computer memory device.

2. Description of Related Art

Double data rate II (DDR2) SDRAM and (DDR3) SDRAM memories are widely used. However, the DDR2 or DDR3 SDRAM memories used nowadays are not hot-swappable devices.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a computer memory device.

FIG. 2 is an enlarged view of the encircled portion II in FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

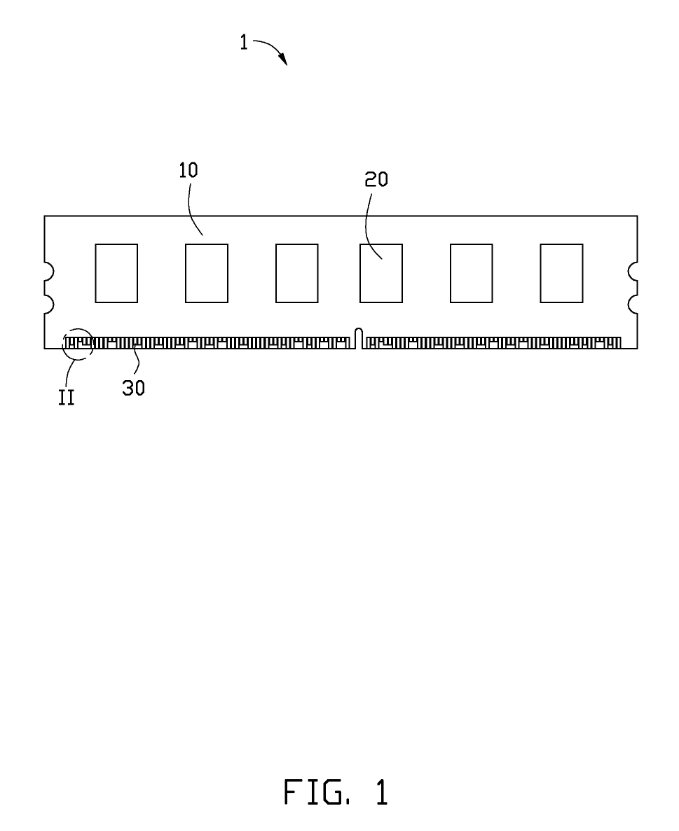

Referring to FIG. 1, an exemplary embodiment of a computer memory device 1 includes a circuit board 10, a plurality of memory chips 20, and an edge connector 30.

The memory chips 20 are mounted on a surface of the circuit board 10. The edge connector 30 is set on a bottom side of the circuit board 10, and electrically connected to the memory chips 20 through traces on the circuit board 10. When the computer memory device 1 is plugged into a memory slot on a motherboard, the edge connector 30 is electrically connected to pins of the memory slot. As a result, the memory chips 20 are connected to the motherboard.

The edge connector 30 includes a plurality of pins. Top ends of the pins are in alignment with one another. The edge connector 30 includes ground pins, power pins, and data pins, all of which are configured according to either the double data rate II (DDR2) or the DDR3 specification.

In the embodiment, the computer memory device 1 is a DDR2 SDRAM memory including 240 pins. The ground pins include 64 pins. The power pins include 24 pins. The data pins include 141 pins. In addition, the computer memory device 1 further includes 11 reserved pins.

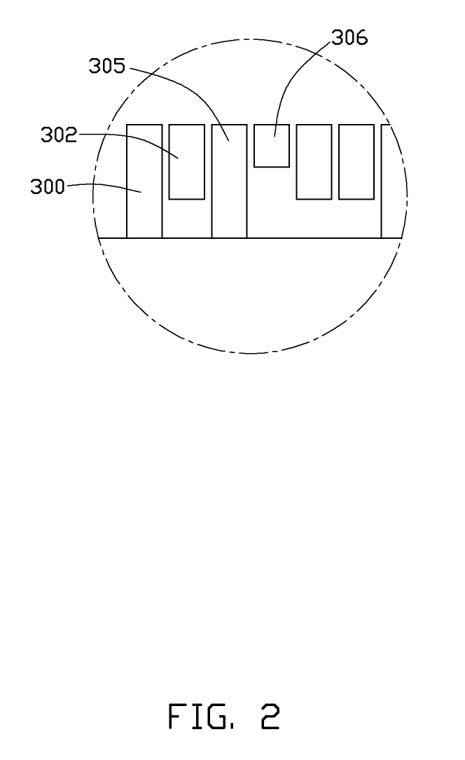

Referring to FIG. 2, a first pin 300 is a ground pin, a second pin 302 is a power pin, a third pin 305 is a ground pin, and a fourth pin 306 is a data pin. The top ends of the first to fourth pins 300, 302, 305, and 306 are in alignment with one another. The first pin 300 and the third pin 305 (namely the ground pins) are the longest. The second pin 302 (namely the power pin) is shorter than the first pin 300 or the third pin 305. The fourth pin 306 (namely the data pin) is the shortest. In other words, a distance between a bottom end of the first pin 300 or the third pin 305 and the bottom side of the circuit board 10 is shortest. A distance between a bottom end of the second pin 302 and the bottom side of the circuit board 10 is longer than the distance between the bottom end of the first pin 300 or the third pin 305 and the bottom side of the circuit board 10. A distance between a bottom end of the fourth pin 306 and the bottom side of the circuit board 10 is longest.

Based on the structure described above, when the computer memory device 1 is plugged into the memory slot on the motherboard, the ground pins (namely the first and third pin 300, 305) contact with corresponding pins of the memory slot at first. In other words, the power pin (namely the second pin 302) and the data pin (namely the fourth pin 306) cannot contact with corresponding pins of the memory slot before the ground pins contact with the corresponding pins of the memory slot.

Similarly, when the computer memory device 1 is pulled out from the memory slot, the ground pins are separated from the corresponding pins of the memory slot at last. In other words, the power pin and the data pin can be disconnected from the corresponding pins of the memory slot with the ground pins still connected to the corresponding pins of the memory slot, and the power pin and data pin cannot be connected to the corresponding pins of the memory slot when the ground pins have be disconnected from the corresponding pins of the memory slot. In the embodiment, the second pin 302 is about 0.2 millimeters (mm) shorter than the first pin 300 or the third pin 305. The fourth pin 306 is about 0.2 mm shorter than the second pin 302.

For the other pins of the computer memory device 1, the lengths of the other pins can be set according to the rule described above. For example, each of 64 ground pins is longest. Each power pin is about 0.2 mm shorter than the ground pin. Each data pin is about 0.2 mm shorter than the power pin. Furthermore, the length of each power pin can be the same with the length of each data pin, and each ground pin is longer.

As a result, the computer memory device 1 can be a hot-swapped device.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A computer memory device comprising:
a circuit board;
a plurality of chips mounted on a surface of the circuit board; and
an edge connector set on a bottom side of the circuit board, the edge connector comprising a plurality of ground pins, a plurality of power pins, and a plurality of data pins, top ends of the ground pins, the power pins, and the data pins are in alignment with one another, each ground pin is longer than each of the power pins and the data pins.

2. The computer memory device of claim 1, wherein each ground pin is about 0.2 millimeters longer than each power pin.

3. The computer memory device of claim 1, wherein each power pin is longer than each data pin.

4. The computer memory device of claim 3, wherein each power pin is about 0.2 millimeters longer than each data pin.

5. The computer memory device of claim 1, wherein the length of each power pin is the same with the length of each data pin.

6. A computer memory device comprising:
a circuit board;
a plurality of chips mounted on a surface of the circuit board; and
an edge connector arranged on a bottom side of the circuit board, wherein the edge connector comprises a plurality of ground pins, a plurality of power pins, and a plurality of data pins, top ends of the ground pins, the power pins, and the data pins are in alignment with one another, a distance between the bottom side of the circuit board and a bottom end of each ground pin is shorter than a distance between the bottom side of the circuit board and a bottom end of each of the power pins and the data pins.

7. The computer memory device of claim 6, wherein the distance between the bottom side of the circuit board and the bottom end of each ground pin is about 0.2 millimeters shorter than the distance between the bottom side of the circuit board and the bottom end of each power pin.

8. The computer memory device of claim 6, wherein the distance between the bottom side of the circuit board and the bottom end of each power pin is shorter than the distance between the bottom side of the circuit board and the bottom end of each data pin.

9. The computer memory device of claim 8, wherein the distance between the bottom side of the circuit board and the bottom end of each power pin is about 0.2 millimeters shorter than the distance between the bottom side of the circuit board and the bottom end of each data pin.

10. The computer memory device of claim 6, wherein the distance between the bottom side of the circuit board and the bottom end of each power pin is the same with the distance between the bottom side of the circuit board and the bottom end of each data pin.
